(19) United States
(12) Patent Application Publication
(10) Pub. No.: US 2005/0003172 A1
(43) Pub. Date: Jan. 6, 2005

(54) 7FAstage 1 abradable coatings and method for making same

(75) Inventors: James Donald Wheeler, Greenville, SC (US); Farshad Ghasripoor, Scotia, NY (US); Chek Beng Ng, Albany, NY (US); Raymond Edward Chupp, Glenville, NY (US); Donald Joseph Baldwin, Galway, NY (US); Yuk-Chiu Lau, Ballston Lake, NY (US); Tara Easter McGovern, Simpsonville, SC (US)

Correspondence Address: NIXON & VANDERHYE P.C./G.E., 1100 N. GLEBE RD., SUITE 800, ARLINGTON, VA, 22201, US

(73) Assignee: General Electric Company, Schenectady, NY (US)

(21) Appl. No.: 10/895,886

(22) Filed: Jul. 22, 2004

Related U.S. Application Data
(63) Continuation-in-part of application No. 10/320,480, filed on Dec. 17, 2002.

(51) Int. Cl. B05D 3/02; B32B 3/00

(52) U.S. Cl. 428/210; 427/446; 427/372.2; 428/195.1; 428/632

(57) ABSTRACT

A method of applying a profiled abradable coating onto a substrate in which an abradable ceramic coating composition is applied to a metal substrate using one or more coating application techniques to produce a defined ceramic pattern without requiring a separate web or grid to be brazed onto the substrate. The invention is particularly designed to withstand the higher operating temperatures encountered with the stage 1 section of 7FA+e gas turbines to allow for increased coating life without significant deterioration in structural or functional integrity. Typically, the grid pattern coating begins approximately 0.431″ after the leading edge of the shroud, and ends approximately 1.60″ before the trailing edge of the shroud. In the case of diamond-shaped patterns, the grid pattern will be about 0.28″ long and 0.28″ wide, with an overall thickness of about 0.46.″ The coatings thus provide the required levels of abradability and leakage performance and may be applied as a chevron or diamond pattern with the shape oriented such that the diagonals run perpendicular and parallel to the sides of the shroud.

This application is a continuation-in-part of commonly-owned application Ser. No. 10/320,480, filed Dec. 17, 2002, the entire disclosure of which is hereby incorporated by reference.

The present invention relates to high temperature abradable coatings and to the method for making such coatings. Specifically, the invention, provides patterned high temperature abradable coatings, i.e., coatings having defined patterns for use on stage 1 shrouds without bucket tipping. Normally, in order to abrade high temperature abradable coatings, particularly ceramic abradables, reinforcing the bucket tip with a material having high strength characteristics at elevated temperatures is a necessity. In such cases, materials such as cubic Boron Nitride, silicon carbide or like materials are often used either in the form of entrapped coarse grits or a fine coating applied by a process such as, for example, thermal spray process, direct-write technology, PVD or CVD.

### BACKGROUND OF THE INVENTION

It is well known to use materials that abrade readily to form seals between a rotating part and a fixed part, whereby the moving part erodes a portion of the abradable material to form a seal having very close tolerances. An important application of abradable seals arise in gas turbines, in which a rotor consisting of a plurality of blades mounted on a shaft rotates inside a shroud. By minimizing the clearance between the blade tips and the inner wall of the shroud, it is possible to reduce leakage of gas across the blade tip and thereby maximize turbine efficiency. This reduced leakage may be achieved by coating the inner surface of the turbine shroud with an abradable material so that rotation of the blades and contact with inner surface causes wear of the abradable material to form grooves in the abradable coating. As the turbine blades rotate, they expand due to centrifugal effects and heat absorption/retention during normal operation. The differential expansion rate between the rotor and the inner shroud results in the tips of the blades contacting the abradable material to carve precisely defined grooves in the coating without contacting the shroud itself. In this way, an essentially custom-fitted seal with minimal leakage is provided for the turbine.

Typically, high temperature abradable coatings comprise a continuous porous ceramic coating, e.g., yttria stabilized zirconia, applied directly to the shroud. The blade tip is also coated/reinforced with abrasive grits such as cubic boronitride (cBN). Drawbacks of this system are the short lifespan of the cBN at the anticipated high operating temperatures and the complexity of the tipping process. See, for example, U.S. Pat. Nos. 6,194,086 and 5,997,248.

U.S. Pat. No. 6,251,526B1 describes a “profiled” abradable ceramic coating system in which a porous ceramic coating is deposited onto a substrate with a profiled surface, e.g., a web or metal grid brazed onto the substrate surface (see FIG. 1), thereby forming an abradable profiled surface with a defined grid pattern. The profiled surface can be made in different forms as described in U.S. Pat. No. 6,457,939B21. A drawback of this method is that the grid must be brazed directly onto the substrate, and permanent damage can result to the shroud during profiling.

Thus, despite recent improvements in high temperature abradable coatings, a need still exists for an abradable coating system that does not require blade tipping and does not have to be profiled through a potentially destructive method such as brazing a grid structure.

### BRIEF DESCRIPTION OF THE INVENTION

It has now been discovered that an abradable coating system can be provided that does not require blade tipping and in which profiling of the substrate surface does not result in damage or otherwise compromise the structural integrity of the substrate. In one aspect, the invention utilizes direct write technology described in more detail below. In another aspect, the invention provides a method of producing a profiled abradable coating on a substrate comprising thermal spraying, e.g., air plasma spraying, an abradable ceramic or metallic coating composition through a mask onto a substrate in the absence of a grid.

Significantly, the invention does not utilize a grid or a web that is bonded or brazed to the substrate. Thus, no profiling of the abradable coating occurs that might otherwise result in damage to the substrate. The invention is applicable to many land-based as well as aviation or marine turbine components and also to the repair of serviced turbine components.

In yet another aspect, a new method is provided for producing a profiled abradable coating on a substrate comprising thermal spraying, e.g., plasma spraying, an abradable ceramic coating composition onto a substrate using a narrow foot-print plasma gun that can be manipulated by a robot to create the desired pattern.

In another aspect, an improved method of producing a profiled abradable coating on a substrate comprises thermal spraying, e.g., air plasma spraying or HVOF spraying, a profiled metallic bond coating having a composition such as MCrAlY where M can be Ni, NiCo or Fe, through a mask, or by using a narrow foot-print plasma gun to spray the metallic bond coat onto a substrate, followed by plasma spraying a ceramic topcoat that conforms to the profiled pattern of the bond coat and forms a profiled abradable surface.

In a further aspect, the present invention provides a method of producing a profiled abradable coating on a substrate whereby the profiled abradable ceramic or metallic coating composition is applied directly to a substrate by employing direct-write technology.

The profiled coatings themselves as produced by the above methods of the invention form yet another aspect of the invention.

The present invention is particularly applicable to high temperature (≧1700° F.) abradable coating systems employed for stage 1 (“S1”) gas turbine shrouds, such as F-class S1 shrouds. The coating system has the advantages of long life (up to 24,000 hours) at operating temperatures ≧1700° F., with essentially zero or minimal blade/bucket wear, and no requirement for blade/bucket tipping. This results in substantially reduced hot gas leakage over the bucket tips and overall improved turbine efficiency.

In a still further aspect, the invention includes exemplary design parameters for the grid coatings as applied to gas turbine shrouds, particularly coatings having a chevron or diamond grid configuration as described herein. The invention also includes a range of preferred operating conditions for the method of applying profiled abradable coatings of various geometric configurations, as well as the sequence of processing steps employed to form grid patterns using different configurations, particularly chevron or diamond patterns.

The invention has particular utility in applications involving 7FA+e stage 1 turbine shrouds. In such applications, a coating of yttria-stabilized zirconia (YSZ) is applied to the surface of the stage 1 shroud in the form of a chevron or diamond pattern with peaks approximately 40 mils (0.040 inches) high. As noted above, the abradable grid pattern serves to reduce the airflow over the bucket tips by minimizing the clearance between the blade tips and the inner wall of the shroud, thereby improving overall engine performance. The use of such grid patterns in accordance with the invention also allows the YSZ coating to be abraded by un-reinforced turbine bucket tips upon contact with the profiled grid pattern, resulting in only minimal tip loss damage to the buckets themselves.

In the past, one known technique for reducing tip clearances at high temperatures utilized a flat coating of polyester impregnated nickel aluminide applied to the metal substrate. The disadvantage of this method is that it cannot achieve the necessary oxidation life expectancy (e.g., 24,000 hours) for stage 1 shrouds at temperatures above 1650 degrees Fahrenheit. Thus, such prior art coatings cannot be used as effectively with 7FA+e stage 1 turbine shrouds. In contrast, the present invention is designed to withstand the higher operating temperatures encountered with the stage 1 section of 7FA+e gas turbines to allow for a coating life up to 24,000 hours without significant deterioration in the structural or functional integrity of the shroud.

In the context of 7FA+e stage 1 shrouds, a YSZ coating normally is applied onto the Shroud by plasma spraying Sutzer-Metco XPT-395 powder (GT56). The coating nominally begins about 0.43″ after the leading edge of the shroud and ends approximately 1.60″ before the trailing edge. In one embodiment, the coating is sprayed on as a chevron or diamond pattern with the diamond shape approximately 0.28″ long and 0.28″ wide (and with an approximate 0.41″ diagonal) oriented such that the diagonals are perpendicular and parallel to the sides of the shroud. A flash coating approximately 0.005″ thick can also be applied either before or after the initial pattern is formed to provide extra strength and hold the pattern cells together. The peaks of the diamond pattern in this particular embodiment are approximately 0.040″ high.

As described below, the patterned abradable coatings according to the invention can be applied with or without a metallic bond coat. Normally, somewhat better bond strengths are achieved with sprayed coated shrouds as compared to polished coated shrouds. The invention thus contemplates using a coated shroud that can be left in its as-sprayed condition in certain areas, with the areas not covered by the abradable coating being polished or machined.

### BRIEF DESCRIPTION OF THE DRAWINGS

FIG. 1(a) shows a typical porous TBC applied on a metal substrate surface with a metal grid brazed onto the substrate surface;

FIG. 1(b) depicts a blade tip showing minimal wear (the rub test was performed at 1830° F.). The blade in this test was not coated with an abrasive coating;

FIG. 2 shows exemplary profiled abradable ceramic coatings according to the invention;

FIG. 3a shows a profiled ceramic abradable coating of the invention deposited by plasma spraying through a metal mask with a 90° chevron pattern. FIG. 3A relates to a first sample that was rub tested at 1500° F. and at a 770 feet per second tip velocity. The rub groove is clearly visible in the center of the sample;

FIG. 3b shows a diamond-like profiled ceramic abradable coating according to the invention as deposited by plasma spraying first through a 90° chevron metal mask, followed by rotating the mask 180° and spraying a second 90° chevron pattern over the first one;

FIG. 4 shows a profiled ceramic abradable coating of the invention deposited by a narrow-foot-print plasma gun, e.g., a Praxair Model 2700 plasma gun;

FIG. 5 shows examples of contoured stripes used according to the invention (e.g., straight diamond, contoured diamond, chevron, brick and honeycomb);

FIGS. 6a-c show rub-tested samples with a chevron and squared diamond profiled ceramic abradable coating of the invention and the tested blades that were not reinforced with any coating;

FIG. 7 shows various known bucket tip configurations;

FIG. 8 shows one of the samples embodying the invention after 1000 cycles with no visual spallation of the abradable coating or the TBC;

FIG. 9 shows the processing sequence for creating patterned abradable coatings in accordance with the invention with the order of steps listed in sequence from formation of the coating through final heat treatment;

FIG. 10 illustrates an exemplary fabrication process for creating diamond-shaped patterns for abradable coatings according to the invention, including the relative dimensions of the various components of the grid pattern being formed;

FIG. 11 depicts a photomicrograph, taken in cross-section, of a typical patterned coating according to the invention illustrating the various layered components and relative exemplary dimensions of the grid segments; and

FIG. 12 depicts the mechanical shear strength of the ridges defining a patterned abradable coating according to the invention as applied to a metal shroud, in this case a chevron or diamond pattern.

### DETAILED DESCRIPTION OF THE INVENTION

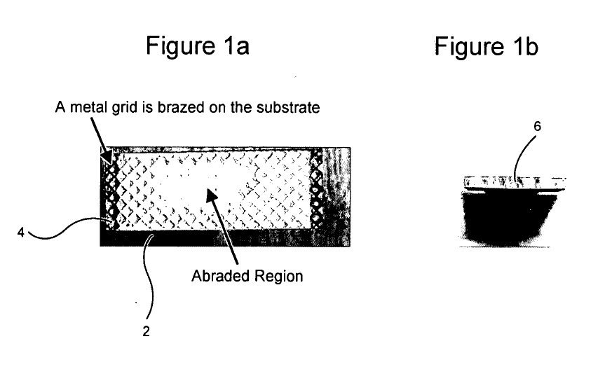

Referring to the figures, FIG. 1(a) shows a typical porous thermal barrier coating (“TBC”) 2 applied on a metal substrate surface with a metal grid 4. FIG. 1(b) depicts a blade tip 6 showing minimal wear, with the rub test being performed at 1830° F.

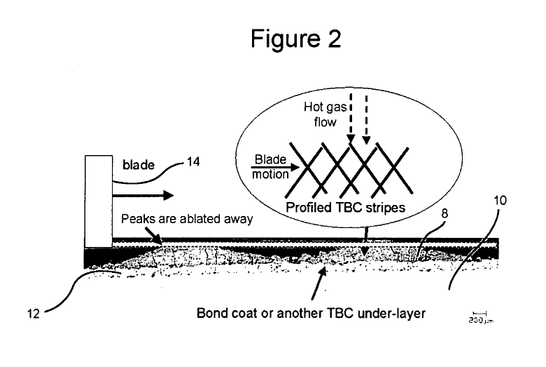

FIG. 2 shows a profiled abradable ceramic coating 8 of the invention, wherein the profiled abradable coating is applied onto the substrate 10 without destructively altering the metal substrate surface structure. Coating 12 can be a metallic bond coat such as MCrAlY, or another ceramic layer such as YSZ or barium strontium aluminosilicate (BSAS) as shown beneath the abradable coating. As the blade 14 passes over the coating 8, the peaks are abraded away to provide a minimum clearance between the blade and the substrate, ensuring minimum leakage.

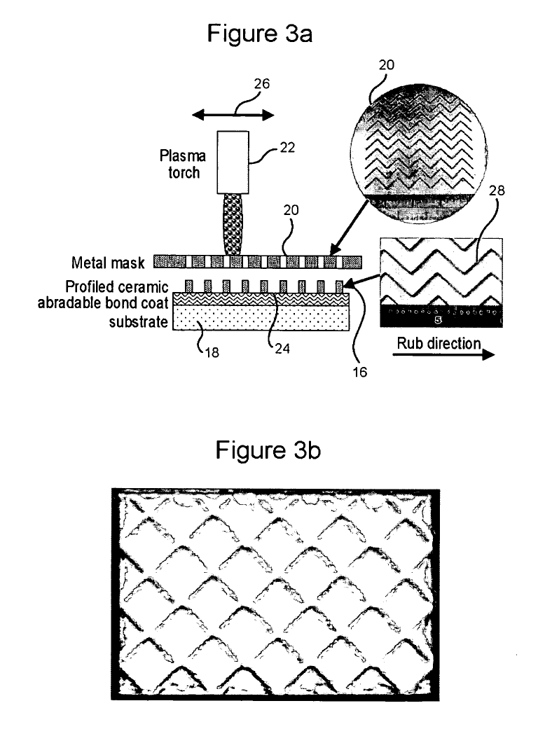

FIG. 3a depicts one approach of the present invention whereby the profiled coating 16 is applied to a substrate 18, for example a metallic bond coat or another ceramic layer such as YSZ or BSAS 24, using a thermal spray process such as air plasma spray, using a mask 20. The plasma torch 22 moves over the mask 20 as shown by the arrow 26 and the profiled coating 16 is formed on the bond coat 24. The chevron shape that is produced by the mask is shown at 28.

Alternatively, a diamond shape abradable coating as depicted in FIG. 3b can be produced by a two-step spray process, i.e., by first plasma spraying through a 90° chevron metal mask followed by rotating the mask 180° and spraying a second 90° chevron pattern over the first layer.

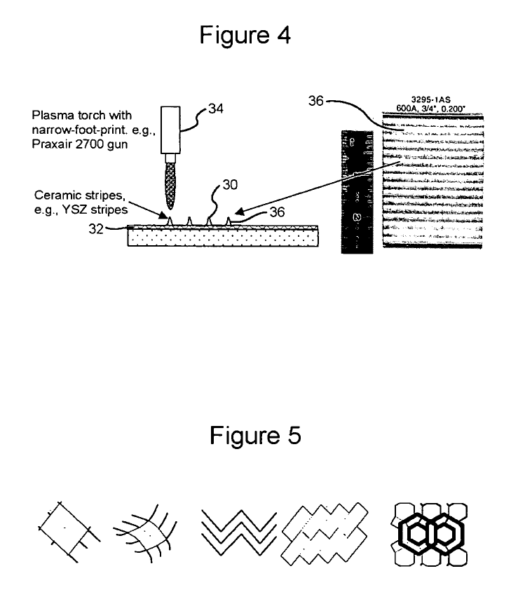

FIG. 4 depicts an alternative approach of the present invention whereby the profiled coating 30 is applied to a substrate 32, for example a metallic bond coat or another ceramic layer such as YSZ or BSAS, by plasma spraying using a narrow-foot-print plasma gun 34. A thermal spray robot can be used to manipulate the plasma gun to form a profiled pattern. One example of a plasma gun that may be employed for this purpose is a Praxair 2700.

The profiled abradable coating can also be in the form of stripes 36 of porous ceramic coatings of yttria stabilized zirconia (YSZ), e.g., Sulzer Metco XPT395, 7 wt % yttria stabilized zirconia (with about 12 to 15 wt % polyester that can be burned off (oxidized) after deposition to form a more porous coating) as in the case of thermal barrier coatings, or barium strontium aluminosilicate (BSAS) (with 12 wt % to 20 wt % polyester for porosity control) as in the case of environmental barrier coatings for Si-based ceramic matrix composite (CMC) components.

The pattern of the coating stripes can also be optimized for both abradability and hot gas sealing. For example, the pattern can be straight or contoured/curved diamond, or chevron in form (see item 28). Examples are presented in FIG. 5, and (from left to right) include straight diamond, contoured diamond, chevron, brick and honeycomb.

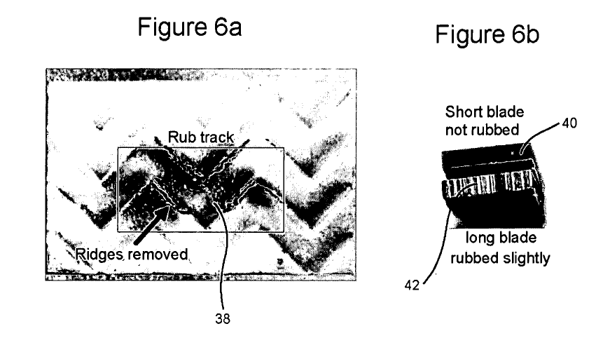

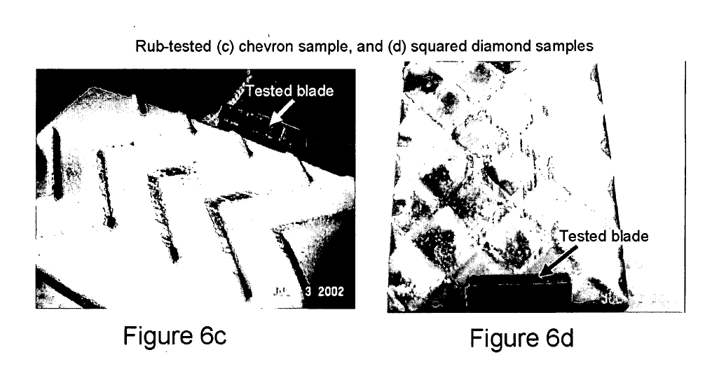

FIG. 6a depicts a rub-tested sample with a profiled ceramic abradable coating 38 according to the invention along with two tested blades 40,42. In general, in order to rub without blade tipping, the angle of the stripes should not form a continuous line with the squealer tip of the blade in the direction of rotation. Angles of more than 60 degrees from any point of the blade tip relative to the sliding line are undesirable. FIGS. 6b and 6c show rub-tested samples with a Chevron and squared diamond profiled ceramic abradable coating of the invention, together with the tested blades that have not been reinforced with any abrasive coating.

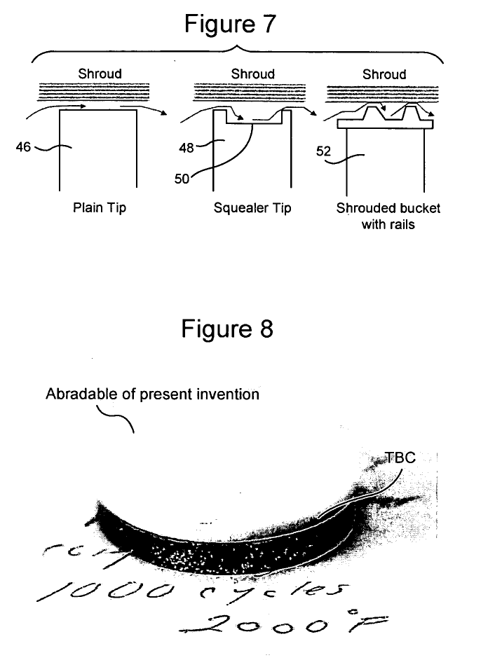

FIG. 7 shows various known bucket tip configurations. A plain tip 46 comprises a flat tip with flow leaking through a constant area across the blade. A “squealer” tip 48 has a profile of a groove 50 that increases the area, stalls the flow creating a back pressure that restricts the flow and reduces heat transfer. A shrouded bucket with rails 52 restricts flow in a similar way.

Preferably, the stripes according to the invention should form closed paths in the flow direction with the aim being to reduce clearance between the bucket tip and the shroud. Since the abradable ceramic cannot be a continuous layer and still reduce clearance, it is formed into intermittent ridges. The tips of the ridges provide the clearance reduction and at the same time allow abradability. The ridges, however, tend to block the flow of air over the blade/bucket tip. Thus, the patterns by which the ridges are joined together are aimed at blocking the air flow. An optimum ridge pattern is therefore one that achieves the following:
Reduced air flow over the blade/bucket tips;
The least pressure losses in the main core flow along the outer flow-path wall between the blade/bucket tips;
Best abradability, i.e., minimum blade/bucket tip wear w/o tip reinforcement; and
Best low angle erosion resistance of the ridge walls.

The ridge pattern is defined by the height of ridge, the width of ridge at the tip and the base near the substrate, and the size of the cells formed by the ridges.

As noted above, the present invention also provides a method of producing a profiled abradable coating on a substrate by applying an abradable ceramic and/or metallic coating composition directly onto a substrate without any need to incorporate a web or metal grid brazed onto the substrate surface. Various methods exist to direct-write or transfer material patterns for rapid prototyping and manufacturing on any surface. Typically, a pen dispensing apparatus can be employed, such as one manufactured by OhmCraft or Sciperio. The abradable pattern applied by such equipment can be controlled by a computer connected to a CAD/CAM having the desired pattern. The powder is formulated to a consistency similar to that of toothpaste (usually called a “fluid slurry” or “ink”), and then applied to the substrate at room temperature. The pattern is subsequently sintered at elevated temperatures as known in the art (e.g., furnace treatment or local consolidation by laser or electron beams). Typically, the powder is formulated to the appropriate consistency using an alcohol such as terpineol. Cellulose may also be added to impart suitable flow characteristics to the powder. The same methodology can be adapted to allow for deposits on highly curved, nonplanar surfaces.

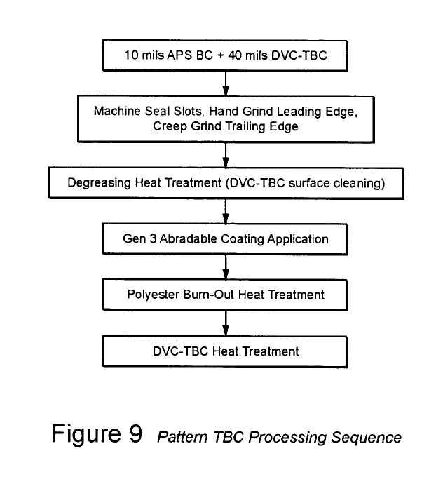

FIG. 9 shows an exemplary processing sequence for creating patterned abradable coatings according to the invention, with the preferred order of steps shown from initial formation of the coating through final heat treatment.

The first step involves the application of an air plasma spray bond coat (designated as “APS BC”). In this example, the bond boat is approximately 10 mils in thickness and includes a dense vertically cracked barrier coating (approximately 40 mils thick). It has been found that the use of an initial APS bond coating tends to improve adherence of the DVC-TBC layer to the metal substrate.

Step 2 involves three pre-treatment steps, namely machining the shroud seal slots, hand grinding the leading edges of the shroud and machine grinding the trailing edges.

In step 3, the DVC-TBC surface is cleaned (degreased) using a conventional heat treatment step to remove any residual grease, dirt or other impurities that might adversely affect the adhesion of the patterned abradable coating as applied to the DVC. In step 4, the grid pattern is applied in one or more steps, for example in the case of a diamond pattern, by applying the top half of the diamond grids in a first pass, followed by a second pass to create the second half of the grid, and then a third pass to provide a final flash coating over the entire grid. Alternatively, the flash coating can be applied first, followed by application of the two halves of the diamond pattern.

Step 5 in FIG. 9 reflects a standard “burn out” treatment (such as in a vacuum oven), whereby polyester material resident in the coating (or other components capable of oxidizing) are removed during the burn out process to create a desired level of porosity and abradability of the final coating.

Finally, in step 6, the entire bucket shroud with the completed grid pattern in place is heat treated and hardened, resulting in the formation of dense vertical cracking.

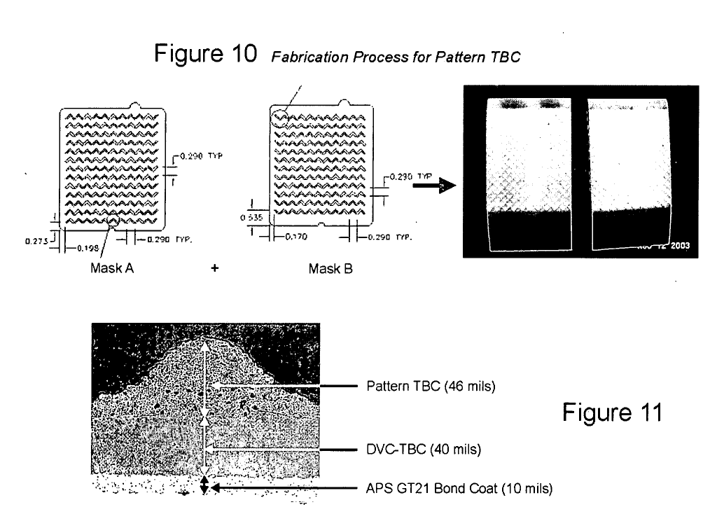

FIG. 10 shows an exemplary fabrication process for creating diamond-shaped patterns for abradable coatings according to the invention. The relative dimensions of the grid pattern being formed are also shown, in this case a diamond-shaped pattern created using multiple passes to apply separate layers of the ceramic coating as described above. The first half of the grid pattern is created in a first application of the coating as illustrated in the plan view of mask “A,” with the dimensions in inches defining the nominal spacing between the top, bottom and side edges of the grid and the corresponding top, bottom and side edges of the metal substrate (typically 0.273, 0.273 and 0.198 inches respectively). Mask “B” also depicts the nominal distance between the top (peak) of one row in the diamond grid relative to a corresponding peak in the next row, and shows the nominal distance between adjacent peaks defining the individual diamond patterns in the same row (approximately 0.290 inches).

In like manner, mask B shows the dimensions for the second half of a typical ceramic grid pattern coating as applied in a second pass, again with the nominal dimensions shown for the spacing between the top, bottom and side edges of the grid pattern and the corresponding top, bottom and side edges of the metal substrate (typically 0.535, 0.535 and 0.170 inches, respectively). Mask A also depicts the nominal distance between the top of one row in the diamond grid relative to a corresponding peak in the next row, and shows the nominal distance between adjacent peaks that define the individual diamond patterns in the same row (again, about 0.290 inches).

As those skilled in the art will appreciate, the dimensions and grid pattern geometries depicted on FIG. 9 are exemplary in nature and can vary, depending on the exact area of the target substrate receiving the pattern, the dimensions of the metal substrate itself and the specific end use application involved. In addition, many grid patterns other than diamond or chevron-shaped patterns (such as squares, rectangles, triangles or other repeating straight or curved geometric shapes) can be used, again depending on the particular end use application and the specific abradable coating composition. Thus, the pattern of the coating can be optimized for both abradability and desired sealing capability.

When the coating is sprayed in the form of a diamond pattern as described above, the diamond shape will be approximately 0.28″ long and 0.28″ wide (with an approximate 0.41″ diagonal) and oriented such that the diagonals are consistently perpendicular and parallel to the sides of the shroud. Nominally, the coating will begin approximately 0.43″ after the leading edge of the shroud and end approximately 1.60″ before the trailing edge.

FIG. 11 is a photomicrograph, taken in cross-section, of a typical pattern coating illustrating the layered components and relative dimensions for ceramic grid patterns (in this case diamond-shaped) as applied to a shroud in accordance with the invention. FIG. 11 shows the bond coating sprayed directly onto the 7FA+e Stage 1 shroud, in this instance an air plasma spray bond coat (AP GT21) approximately 10 mils thick, followed by a second layer comprising a dense vertically cracked barrier coating approximately 40 mils thick. The thermal barrier coating (“TBC”) as described above is depicted with a thickness at the peak of the diamond pattern of about 46 mils.

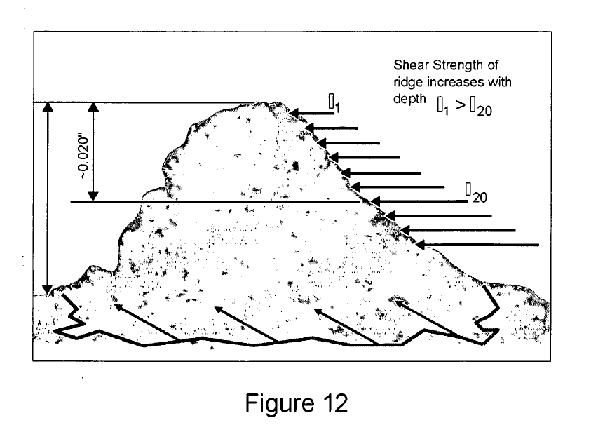

FIG. 12 illustrates the relative shear strength of the exposed ridges of exemplary patterned abradable coatings according to the invention (here, a diamond pattern approximately 40 mils thick) as applied to a metal shroud. FIG. 12 also indicates that the shear strength increases with increasing depth. As such, coatings according to the invention are particularly well suited for use at the higher operating temperatures encountered with the stage 1 section of 7FA+e gas turbines and typically result in an extended coating life without significant deterioration in structural or functional integrity.

### EXAMPLES

### Example 1

### Profiled Ceramic Abradable Coating via Plasma Spraying through Masking (FIG. 3), Rub Tested at 1500F Temperature

In this example, a metal mask was fabricated by water-jet cutting a 90° chevron pattern (see FIG. 3) onto a ⅛″ thick steel plate. The width of groove was 0.05″ on the plasma gun side and 0.06″ on the substrate side. The spacing between the grooves was about 0.2.″ The substrate comprised a 5″×5″ IN718 plate which was grit-blasted with 60 mesh virgin Al₂O₃ grit at 60 psi air. A 0.006″ thick metallic bond coat of Praxair Ni211-2 (NiCrAlY) was applied onto the substrate followed by the application of 0.04″ thick profiled ceramic top coat of Sulzer Metco XPT395 (7% YSZ with 15 wt % polyester) through the metal mask (see FIG. 3).

Table 1 lists the plasma and spray parameters for the bond coat and the ceramic top coat.

TABLE 1

| | |
|---|---|
| Bond coat | Top coat |

PLASMA SPRAY EQUIPMENT

| GUN MFR./MODEL NO.: | METCO 7 MB | |
|---|---|---|
| NOZZLE (ANODE NO.): | G | G |

| | |
|---|---|
| ELECTRODE (CATHODE NO.): | 7B63 |

ARC GAS SETTINGS

| PRIMARY GAS TYPE: | N2 | N2 |
|---|---|---|
| FLOW: SCFH | 155 | 75 |
| SECONDARY GAS TYPE: | HYDROGEN | |
| FLOW: SCFH | 10 | 19 |

POWER SETTINGS

| | | |
|---|---|---|
| GUN CORRENT: A | 500 | 500 |

POWDER FEED SETTINGS

| | | |
|---|---|---|
| POWDER FEED RATE (LBS/HR): | 6 | 10 |
| CARRIER GAS | N2 | N2 |
| CARRIER GAS FLOW: SCFH | 13 | 10 |
| POWDER PORT NUMBER (METCO): | #2 | #2 |

COATING DATA

| | | |
|---|---|---|
| STAND OFF DISTANCE: in | 5 | 4.5 |
| GUN SPEED, mm/sec | 600 | 760 |
| STEP SIZE, mm | 6 | 6 |
| ROBOT | M710i | M710i |

COOLING AIR REQUIREMENTS:

| | | |
|---|---|---|
| NO. OF PLASMA GUN AIR JETS | 2 | 2 |
| PLASMA GUN AIR JET PSI | 70 | 40 |
| AUX NO. OF AIR JET REQUIREMENT: | 0 | 2 |
| PRESSURE (PSI): | N/A | 10 |

After the profiled ceramic top coat was applied, the metal mask was removed and an additional layer of ˜0.002″ thick ceramic top coat of Sulzer Metco XPT395 was applied over the profiled ceramic coating. After the coating operation, the polyester in the ceramic coating was burned off (oxidized) in an air furnace at ˜500° C. for 4 hours.

The test samples were then water-jet cut from the heat-treated substrate and rub test was performed using the GE GRC rub rig. The test conditions were: 2 untipped GTD111 (Ni-based superalloy) blade, 770 ft/sec blade tip velocity, 1500° F. test temperature and 0.0001 in/sec incursion rate. Repeated test results indicated that the test blade rubbed with a low blade wear of ˜3-7% of the total incursion depth of ˜0.04″ and removed the ridges from the profiled ceramic top coat. FIGS. 6a-c show the rubbed samples and the tested blades. It should be noted that cutting the ceramic is a function of the blade tip speed, i.e., the higher the speed the better the cut due to the kinetic energy that is carried by the blade(s)/cutting element.

### Example 2

More samples were prepared with chevron (as described in 0027) as well as diamond patterns (as described in 0016). These samples (FIG. 6) were rub tested at 1050 ft/s tip velocity, where only one untipped cutting blade of GTD111 was used. The tests were conducted at 1700F temperature. Test data with these samples indicate, blade wear of 0-6% of the total incursion depth of 0.04″ which removed the ridges from the coatings in both types of patterns.

### Example 3

More samples were prepared with chevron patterns (as described in 0039) on previously TBC-coated Rene N5 samples. These samples were then thermal-cyclic tested in a high temperature air furnace at 2000° F. The test cycle was: ramp up to 2000F in 15 min., hold at 2000° F. for 45 min., and cool to room temperature in 10 min. FIG. 8 shows one of the samples after 1000 such cycles and there is no visual spallation of the abradable coating as well as the TBC. This test result indicates the compatibility of the patterned abradable coating to TBC in thermal cyclic performance.

### Example 4

Rub test were performed to test the abradability of the coating and the bond strength of the coating adhesion to the shroud and to verify that the coating resulted in minimal blade wear. With an incursion of 0.028″ to 0.030″ deep into the abradable coating, the maximum blade wear (as a percentage of incursion depth) was 11.567%, with no ridge breaks or delamination.

A thermal shock test and furnace cycle tests were then performed on the Example 4 samples. The samples were coated exactly to the composition and microstructure of the 7FA+e coating to simulate the parts. In the thermal shock test, a test sample was heated from room temperature to 2550 degrees Fahrenheit over a 20 second period, and then cooled back to room temperature over a 20 second span. The sample was then held at room temperature for 40 seconds, and the process was repeated for 2000 cycles. All samples passed the thermal shock test.

The furnace cycle test ramped the temperature over a 15 minute span from room temperature to 2000 degrees Fahrenheit, where it was held for 45 minutes, before being cooled to room temperature over a ten minute span. The test was then repeated, and ran for at least 27 days (430 cycles) without failure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of applying an abradable ceramic coating having a defined grid pattern onto a substrate comprising the steps of air plasma spraying an initial bond coat onto said substrate, applying a dense vertically cracked thermal barrier coating, heat treating said initial bond coat and said thermal barrier coating, applying an abradable ceramic layer having a defined grid pattern onto said thermal barrier coating, and subjecting said abradable ceramic coating to a second heat treatment.

2. A method according to claim 1, wherein said initial bond coat is approximately 10 mils thick.

3. A method according to claim 1, wherein said dense vertically cracked layer is approximately 40 mils thick.

4. A method according to claim 1, wherein said defined pattern for said abradable ceramic coating comprises a chevron or diamond-shaped grid.

5. A method according to claim 1, wherein said step of applying an abradable ceramic layer further comprises the steps of applying the top half of a ceramic chevron or diamond shaped grid in a first pass, applying the second half of a ceramic chevron or diamond grid in a second pass to thereby form a completed grid pattern, and applying a third ceramic coating in a third pass over the entire grid pattern.

6. A method according to claim 1, wherein said step of applying an abradable ceramic layer further comprises the steps of applying a flash coating of ceramic onto said substrate in a first pass followed by applying the two halves of a ceramic coating to form said defined grid pattern.

7. A method according to claim 1, wherein said abradable ceramic coating begins approximately 0.43″ after the leading edge of said substrate, and ends approximately 1.60″ before the trailing edge of said substrate.

8. A method according to claim 1, wherein said abradable ceramic layer is formed into a chevron or diamond pattern and has a nominal thickness of about 46 mils.

9. A method according to claim 1 wherein said initial bond coat comprises MCrAlY, where M is Ni, NiCO, CoNi or Fe or an inter-metallic of Beta-NiAl.

10. A method according to claim 1 wherein said dense vertically cracked thermal barrier coating comprises yttria-stabilized zirconia or other environmental barrier coatings such as strontium aluminosilicate.

11. A method according to claim 1 wherein said turbine shroud is a 7FA+e stage 1 shroud.

12. A method according to claim 1 wherein said substrate is a turbine shroud made of a superalloy or Si-based ceramic matrix composite.

13. A method according to claim 1 wherein said abradable ceramic coating is in the form of repeating diamond shapes.

14. A method according to claim 0.1 wherein said abradable ceramic coating is in the form of repeating chevron shapes.

15. A substrate having an abradable ceramic coating with a defined pattern produced by the method of claim 1.

16. A turbine shroud having an abradable ceramic coating with a defined pattern produced by the method of claim 1.
